(19) United States
(12) Patent Application Publication
(10) Pub. No.: US 2011/0106554 A1
(43) Pub. Date: May 5, 2011

(54) Health-care rates exchange I

(76) Inventor: Anuthep Benja-Athon, New York, NY (US)

(21) Appl. No.: 12/930,397

(22) Filed: Jan. 6, 2011

Related U.S. Application Data
(63) Continuation of application No. 12/592,714, filed on Dec. 2, 2009.
Application No. 12/592,714 is a continuation-in-part of application No. 12/584,718, filed on Sep. 11, 2009.
Application No. 12/584,718 is a continuation-in-part of application No. 12/381,654, filed on Mar. 16, 2009.
Application No. 12/381,654 is a continuation-in-part of application No. 12/321,141, filed on Jan. 16, 2009.
Application No. 12/321,141 is a continuation-in-part of application No. 12/069,409, filed on Feb. 11, 2008.
Application No. 12/069,409 is a continuation-in-part of application No. 12/156,674, filed on Jun. 4, 2008.
Application No. 12/156,674 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/327,973, filed on Jan. 9, 2006, now abandoned.
Application No. 11/327,973 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 12/322,529, filed on Feb. 4, 2009.
Application No. 12/322,529 is a continuation-in-part of application No. 12/080,433, filed on Apr. 3, 2008.
Application No. 12/080,433 is a continuation-in-part of application No. 12/072,097, filed on Feb. 25, 2008.
Application No. 12/072,097 is a continuation-in-part of application No. 11/242,461, filed on Oct. 4, 2005, now abandoned.

(51) Int. Cl. G06Q 50/00; G06Q 10/00

(52) U.S. Cl. 705/2

(57) ABSTRACT

The present invention provides an improved system and method for creating and generating fixed and adjustable or negotiable charges related to health and health-care services, goods and medications by and between health-care providers and related health-care buyers for implementing and serving in the functioning and operating computerized systems of payments and related disbursements and barters for managing, effecting and controlling said costs, expenses, payments, compensations and revenues of, by and among providers and related buyers in a network or networks of servers, computers and wireless devices, teleconferencing platforms and the Internet.

This application is a continuation-in-part of Ser. No. 12/592,714 filed Dec. 2, 2009 entitled Health-care Exchange IV, a continuation-in-part of Ser. No. 12/584,718 filed Sep. 11, 2009 entitled the Health-care Exchange III, a continuation-in-part of Ser. No. 12/381,654 entitled the Adaptable compositions of health information filed Mar. 16, 2009, a continuation-in-part of Ser. No. 12/321,141 entitled the Best system of health and health-care data management filed Jan. 16, 2009 which is a continuation-in-part of Ser. No. 12/069,409 entitled the Filing of Health and Health-care data filed Feb. 11, 2008, a continuation-in-part of Ser. No. 12/156,674 filed Jun. 4, 2008 entitled a precise medical information retrieval, a continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007 (abandoned), a continuation-in-part of Ser. No. 11/637,662 entitled A vital hierarchy of data on diseases filed Dec. 13, 2006 (abandoned), a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006 (abandoned), a continuation-in-part of Ser. No. 11/477,121 entitled the Medical Vocabulary Templates in Speech Recognition filed Jun. 29, 2006 (abandoned), a continuation-in-part of Ser. No. 11/327,973 filed Jan. 9, 2006 entitled Fidelity of physicians' thoughts to digital data conversions (abandoned), a continuation-in-part of Ser. No. 11/114,763 entitled A system of influencing health-care utilizations filed Apr. 27, 2005 (abandoned), a continuation-in-part of Ser. No. 11/196,823 entitled Routing of health information files filed Aug. 4, 2005 (abandoned), a continuation-in-part of Ser. No. 11/973,866 entitled An intelligent system of speech recognizing physicians' data (abandoned), a continuation-in-part of Ser. No. 11/293,689 entitled A system of conserving health-care buyers' resources filed Dec. 5, 2005 (abandoned), a continuation-in-part of Ser. No. 11/150,878 entitled Physicians' optimal management of health information filed Jun. 13, 2005 (abandoned), a continuation-in-part of Ser. No. 11/074,236 entitled A system of management of health-care resources filed Mar. 7, 2005 (abandoned), and a continuation-in-part of Ser. No. 11/022,410 entitled Physicians' way of information productions filed Dec. 27, 2004 (abandoned), a continuation-in-part of Ser. No. 12/322,529 filed Feb. 4, 2009 entitled the Healthcare exchange II, a continuation-in-part of Ser. No. 12/080,433 filed Apr. 3, 2008 entitled Healthcare exchange, a continuation-in-part of Ser. No. 12/072,097 filed Feb. 25, 2008 entitled a Method of empowering owners of health-care resources, and a continuation-in-part of Ser. No. 11/242,461 filed Oct. 4, 2005 entitled a Perfect system of compensations for physicians which are pending.

### FIELD OF INVENTION

A computerized system for managing, effecting and controlling health-care costs and compensations of, by and between health-care buyers, consumers and providers in the functioning and operating computerized systems of payments and related disbursements and barters in a network or networks of servers and computers.

### BACKGROUND OF THE INVENTION

The present invention incorporated into said pending patent applications and numerous other patent applications—the Cloud Healthcare Exchange—for achieving and fulfilling said goals and objectives, enterprises and endeavors in said pending patents and the present invention. created a new and, if not the best, better health-care system for people of the world. In fact, said pending patent applications including the present invention uniquely, powerfully and speedily transform the entire and global health-care system human civilizations had and experienced up to 2010 into the most modern and, if not the best, much better, efficient and benevolent health-care system human civilizations have ever known, have and enjoyed in many millenniums to come.

Said pending patent applications, individually or in combinations, are uniquely innovative, achievable and attainable only by the unique means and methods invented by the present applicant and, consequently, the most advanced, powerful and benevolent health-care system benefiting every human, society and humanity on earth.

Empowering said pending patent applications, the present invention is a vital component of said health-care innovations and milestone—the Utopian Healthcare System—in all human civilizations speedily improve the quality and standard of and future innovations in health-care and quality and standard living for people all over the world.

Added to and implemented into said inventions, the present invention provides yet another unique and powerful innovation achievable, attainable and applicable only in said systems and methods of said pending patent applications which further enhance and steadfastly, speedily and infinitely improve the quality and standard of health-care and living for people all over the world.

Further to the claims and descriptions in said pending patent applications, consequently, the present invention together with said pending patent applications are the only means and solution for solving the current health and health-care woes increasing morbidity and mortality affecting Americans and, consequently, producing the best health-care system and spawning innovations in medicine, sciences and health-care the world ever known and will have and immediately and immensely benefiting billions of people and successive generations and humanity.

### SUMMARY OF THE INVENTION

The present invention is a computerized system for generating individual fixed or non-negotiable costs, rates or charges of individual health and health-care services, goods, equipment and medications represented by individual words, terms, phrases and sentences in individual medical and surgical categories by physicians, individual physicians, individual groups of physicians, individual hospitals, individual health-care clinics, individual health-care facilities or individual departments henceforth collectively known as individual providers and for generating negotiable, variable, adjustable and set or agreed individual costs, rates or charges of said individual health and health-care services, goods, equipment and medications by and between individual providers and individual health-care buyers, individual groups of health-care buyers, individual consumers, individual groups of consumers or individual governments henceforth collectively known as individual buyers for implementing and serving in the functioning and operating computerized systems of payments and related disbursements and barters resulting in individual varied and adjusted health-care costs and expenses and related individual payments, compensations and revenues of, by and between said individual buyers and related said individual providers for managing, effecting and controlling said costs, expenses, payments, compensations and revenues of, by and among said individual buyers and related individual providers in a functioning and operating computer server or servers henceforth servers in a network or networks of said servers, computers, laptops, mobile and wireless communication devices, teleconferencing platforms and the Internet being used by said buyers and providers. The present invention, therefore, provides a system and method for implementing and applying said non-negotiations, negotiations, variations, adjustments and sets of said individual costs, rates and charges by and between said individual buyers and related said individual providers as individual prices, monetary values or costs related to said individual words, terms, phrases and sentences for enabling and effecting computer-automatically scanning and matching same, similar and equivalent words, terms, phrases and sentences with said individual words, terms, phrases and sentences, in said functioning and operating computerized systems of payments and related disbursements and barters, in the processor units and memories in said servers. Consequently, the present invention, incorporated into said pending patent applications, is a computerized system and method for managing, effecting and controlling health-care costs and expenses and payments, compensations and revenues of, by and among said individual buyers and related individual providers using computers, laptops, mobile and wireless communication devices for accessing teleconferencing platforms and said servers in a network or networks of said servers, computers, devices, platforms and the Internet.

### BRIEF DESCRIPTION OF THE PREFERRED EMBODIMENTS

To understand the preferred embodiments of the present invention, it is necessary to invoke said earlier pending patent applications such as, but not limited to, Ser. No. 12/592,714 filed Dec. 2, 2009 entitled Health-care Exchange IV, Ser. No. 12/584,718 filed Sep. 11, 2009 entitled the Health-care exchange III, Ser. No. 12/381,654 entitled the Adaptable Compositions of Health Information, Ser. No. 12/321,141 entitled the Best system of health and health-care data management Ser. No. 12/069,409 entitled the Filing of health and health-care data, Ser. No. 12/322,529 entitled the Healthcare exchange II, Ser. No. 12/080,433 filed Apr. 3, 2008 entitled Healthcare exchange, Ser. No. 12/072,097 filed Feb. 25, 2008 entitled a Method of empowering owners of health-care resources, and Ser. No. 11/242,461 filed Oct. 4, 2005 entitled a Perfect system of compensations for physicians which are the functioning and operating computerized systems of payments and related disbursements and barters in a functioning and operating computer server or servers herein.

Said pending patent applications extensively teach and use—a vital component or requisite core—an innovative and unique system and method for computer-automatically and repetitively or continually scanning and matching individual words, terms, phrases and sentences including related individual evaluations, tests, laboratories, procedures, treatments and surgeries, which are integral components of said relational information and data on or related to said individual patients used and use and generated in said devices by said individual physicians in said submissions of said information and data on health, health-care and health-care services related to said individual diagnoses and said physicians and individual patients using said keyboards and interactive Web pages and electronic templates to said servers, and upon said individual inputs of said individual words, terms, phrases and sentences into said processor units and memories, said process for computer-automatically scanning and matching said submitted individual words, terms, phrases and sentences, with same, similar and equivalent words, terms, phrases and sentences related to individual prices, monetary values or costs—the prototype of the present invention—in said processor units and memories and outputting said scanned and matched said words, terms, phrases and sentences and related individual prices, monetary values or costs from said processor units and memories to, to be related and compiled with compiled words, terms, phrases and sentences and related prices, monetary values or costs into adaptable and expanding relational compositions in said SQL databases in said functioning and operating computerized systems of payments and related disbursements and barters in said functioning and operating computer server or servers, enabled and effected by and according to the innovative computer programs and software and stored procedures.

Further to supra, therefore, the present invention provides the system and method for creating and generating an improved, innovative, unique and more versatile computerized system and method for creating and generating individual fixed or non-negotiable costs, rates or charges of individual health and health-care services, goods, equipment and medications represented by individual words, terms, phrases and sentences in individual medical and surgical categories by physicians, individual physicians, individual groups of physicians, individual hospitals, individual health-care clinics, individual health-care facilities or individual departments henceforth collectively known as individual providers and for creating and generating variable, adjustable, negotiable and set or agreed individual costs, rates or charges of said individual health and health-care services, goods, equipment and medications by and between said individual providers and individual health-care buyers, individual groups of health-care buyers, individual consumers, individual groups of consumers or individual governments henceforth collectively known as individual buyers for implementing and serving in said pending patent applications—the functioning and operating computerized systems of payments and related disbursements and barters—resulting in individual varied and adjusted health-care costs and expenses and related individual payments, compensations and revenues of, by and between said individual buyers and related said individual providers for managing, effecting and controlling said costs, expenses, payments, compensations and revenues of, by and among said individual buyers and related individual providers in a functioning and operating computer server or servers henceforth servers in a network or networks of said servers, computers, laptops, mobile and wireless communication devices, teleconferencing platforms and the Internet being used by said buyers and providers.

The present invention provides operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and innovative computer programs and software coupled to, communicating with and commanding said SQL Server, processor units and memories in said servers and teleconferencing technologies. Said network or networks of said servers, computers, laptops, devices and teleconferencing platforms and the Internet are used by said buyers and providers enabled said buyers and providers, using said computers, laptops, devices and teleconferencing platforms and Internet, to access said operating and functioning computer servers including said servers and to interact in teleconferencing platform from anywhere and different and diverse localities in America and other nations on earth.

The present invention provides and uses said innovative computer programs and software and stored procedures for creating, generating, adapting, applying and expanding said adaptable and expanding SQL databases in and manage by said SQL Server and in said processor units and memories to create, manage, implementing and apply the present invention in said functioning and operating computerized systems of payments and related disbursements and barters. Said innovative computer programs and software and stored procedures are described infra in the claims.

Enabled by the present patent applicant and said unique and innovative computer programs and software and stored procedures invented and created by said patent applicant and various applications of said Wordpad, Notepad, .txt programs, JavaScript, AJAX, HTML, .net in said servers, the achievements of the objectives and goals of the present invention by said individual providers and individual buyers are speeded by the creations and generations of adaptable and expanding relations, compositions and compilations of hundreds of thousands of individual words, terms, phrases and sentences, which are integral components of said health, health-care and health-care-service information and data on or relating to diseases and disorders and patients used and use by physicians of all and diverse medical and surgical practices or specialties for and in the communications of said information and data among and between physicians and between physicians and patients, representing medical and surgical words, terms, phrases and sentences in medical and surgical categories such as, but not limited to, Evaluations, Chief Complaints, Allergies, Family Histories, Vital Sign Measurements, Reviews of Systems, Physical Examinations, Infectious Diseases, Diagnoses, Differential Diagnoses, Results of Laboratories such as, but not limited to, Imaging or Imagings, Body Fluid Tests and Tissues Examinations, Assessments and Plans, Immunizations, Medications, Treatments, Surgeries, Recommendations, Guidelines, Advises, Referrals and Follow-ups, etc., and, enabled and effected by and according to said innovative computer programs and software and stored procedures are processed in said processor units and memories and computer-automatically outputted to, to be related and compiled in and related to individual SQL keys in said adaptable and expanding SQL databases in and manage by said SQL Server.

In particular, however, the present invention places emphasis on particular said words, terms, phrases and sentences representing individual payable health-care and health-care services, in said medical and surgical categories of Evaluations, Laboratories, Imaging, Body Fluid Tests and Tissues Examinations, Medications, Drugs, Pharmaceuticals, Devices, Equipment, Procedures, Treatments, Surgeries, Recommendations, Guidelines, Advises, Referrals, Follow-ups, related to individual diagnoses or individual diagnoses in individual groups of same, equivalent or similar diagnoses of diseases and disorders and goods, medications, drugs, pharmaceuticals, equipment, devices, related individual buyers and individual providers and demographic information and data such as, but not limited to, zip codes, area codes, locations, addresses and places of said individual providers and individual buyers related to individual health-care consumers, enabled by and effected in said Wordpad, Notepad, .txt programs, JavaScript, AJAX, HTML, .net and enabled and effected by and according to said innovative computer programs and software and stored procedures in said servers, which are processed in said processor units and memories and computer-automatically outputted to, to be related and compiled in and related to individual SQL keys in said adaptable and expanding SQL databases in and manage by said SQL Server.

Said innovative computer programs and software and stored procedures and JavaScript, AJAX, HTML, .net, Web browsers and Web server, telecommunications technologies enabled the present invention to continually generate and provide various electronic platforms such as, but not limited to, adaptable interactive linked Web pages and electronic templates and numerous linked interactive pop-up and drop-down lists, used extensively in said pending patent applications, upon prompting by said individual computers, laptops, mobile and wireless communication devices, teleconferencing platforms being used by said individual providers and individual buyers in said network or networks. One of the preferred embodiments of the present invention, said adaptable interactive linked Web pages and electronic templates and linked numerous interactive pop-up and drop-down lists comprise adaptable and expanding relations, compositions and compilations of said individual words, terms, phrases and sentences, which are integral components of said health, health-care and health-care-service information and data on or relating to diseases and disorders and patients used and use by physicians of all and diverse medical and surgical practices or specialties for and in the communications of said information and data among and between physicians and between physicians and patient, representing individual payable health-care and health-care services in said medical and surgical categories of Evaluations, Laboratories, Imaging, Body Fluid Tests and Tissues Examinations, Medications, Devices, Equipment, Procedures, Treatments, Surgeries, Recommendations, Guidelines, Advises and Referrals, related to individual diagnoses or individual diagnoses in individual groups of same, equivalent or similar diagnoses of diseases and disorders, and related individual prices, monetary values or costs and related individual buyers and individual providers and demographic information and data on said individual providers and individual buyers related to individual health-care consumers.

One of the innovative and unique preferred embodiments of the present invention creates and computer-automatically and continually provides said related innovative and unique interactive boxes for computer-automatically retrieving and displaying said individual words, terms, phrases and sentences in said categories related to any, diverse and all medical and surgical practices or specialties of said individual providers and relating costs, rates and charges to create, generate, adapt, adjust, expand relations, compositions and compilations of said words, terms, phrases and sentences representing individual payable health-care and health-care services, goods, medications, drugs, pharmaceuticals, equipment, devices and, first, for keyboarding or generating related individual fixed, non-negotiable, or asking costs, rates and charges, and individual negotiable, variable, adjustable, set and reset costs, rates or charges and, second, by keyboarding, for successively or sequentially enabling, adjusting, varying, negotiating, updating and adapting said individual variable, adjustable, negotiable, agreed and set costs, rates and charges and, third, by keyboarding, for sequentially and continually adapting, varying, adjusting, updating, setting and resetting said adaptable relations, compositions and compilations in said adaptable interactive linked Web pages and electronic templates in said viewing screens, processor units, memories and SQL databases by and between individual physicians, groups of physicians, hospitals or health-care clinics or facilities and individual health-care buyers, individual groups of health-care buyers, consumers, groups of consumers or governments using said computers, laptops, mobile and wireless communication devices, teleconferencing platforms and the Internet at and from anywhere, everywhere and different and diverse localities in America and other nations on earth.

First, one of the innovative and unique preferred embodiments of the present invention, said adaptable interactive linked Web pages and electronic templates and linked numerous interactive pop-up and drop-down lists are adaptable to computer-automatically generate a first plurality of components of said computerized system for generating individual relations, compositions and compilations of fixed or non-negotiable costs, rates or charges of individual health and health-care services, goods, equipment and medications in said viewing screens by and related to individual providers related to individual medical and surgical specialties or practices and related in related interactive boxes—numbering in several tens of interactive boxes—and demographic information and data on said individual providers and submitting said relations, compositions and compilations to said processor units, memories and SQL databases from which, subsequently, upon prompting by said individual providers, using said computers, laptops, mobile and wireless communication devices, teleconferencing platforms in said network or networks from anywhere and different and diverse localities, said relations, compositions and compilations are computer-automatically and continually retrieve into said processor units and memories of said servers to be displayed, adapted, adjusted, updated and used in said adaptable interactive linked Web pages and electronic templates and linked numerous interactive pop-up and drop-down lists by said individual providers.

In a nutshell, said preferred embodiment of the present invention in said adaptable interactive linked Web pages and electronic templates in said viewing screens of said computers, laptops, mobile and wireless communication devices, teleconferencing devices being used by said individual providers can be schematically represented by one of said categories of Evaluations comprise at least 20-40 items—and corresponding number of interactive boxes—such as, but not limited to comprehensive consultation, extensive consultation, intermediate consultation, brief consultation, comprehensive office visit, extensive office visit, intermediate office visit, brief office visit, comprehensive, extensive consultation, intermediate consultation, brief consultation, comprehensive hospital consultation, extensive hospital consultation, intermediate hospital consultation, brief hospital consultation, etc. which are schematically and briefly represent in a plurality of rows of said interactive boxes infra as followed:

### Dr. John Doe (JD) and Related Demographic Information and Data

Evaluations Laboratories Imaging Body Fluid Tests and Tissues
Examinations Medications Devices Equipment Procedures Treatments
Surgeries Recommendations Guidelines Advises Referrals

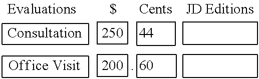

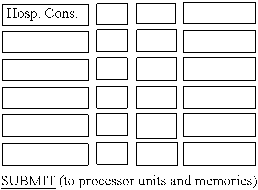

In said schematic one page comprising information and data on said fictitious Dr. John Doe, M.D., as shown supra, prompted said servers to display said schematics in said adaptable interactive linked Web pages and electronic templates and said plurality of linked interactive categories for selecting, clicking, retrieving and displaying all items and related compositions and compilations in said SQL databases in said representative schematics in said viewing screens of said computers, laptops, mobile and wireless communication devices and, teleconferencing devices being used by said Dr. Doe.

Having selected and clicked said interactive Evaluations category—which was Evaluations prior to said selecting and clicking—by Dr. Doe to retrieve relations, compositions and compilations of related information and data in said Evaluations category from said processor units, memories and SQL databases to show said columns and rows of interactive boxes. Schematically, said first three boxes in said first column under said Evaluations heading schematically representing said 20-40 items—not shown in said representation supra—which are computer-automatically generated from said processor units, memories and information and data on said category in said SQL databases and retrieved and displayed in said viewing screens. Subsequently, said $250.44 and $200.60 in said second interactive boxes in said second column under said $ heading and Cents heading—representing the fixed or non-negotiable costs, rates or charges of Consultation and Office Visit, respectively, generated or keyboarded into said interactive boxes by said Dr. Doe. Dr. Doe can complete his fixed or non-negotiable costs, rates and charges for all said 20-40 items related to Dr. Doe and click said interactive SUBMIT to input said relations and compositions related to Dr. Doe to said processor units, memories and SQL databases. Consequently and repetitively, Dr. Doe can retrieve said relations, compositions and compilations in said SQL databases and edit said relations, compositions and compilations in said SQL databases by keyboarding or generating different individual fixed or non-negotiable costs, rates or charges in each said interactive boxes in said column under Editions. In other words, said fictitious physician—representing individual physicians, groups of physicians, hospitals, health-care clinics, facilities or departments or their staff in anywhere and different and diverse localities—can achieve supra and also adjust and reset said relations, compositions and compilations of said individual costs, rates and charges related to individual health and health-care services, goods related to said individual physicians, groups of physicians, hospitals, health-care clinics, facilities or departments and related SQL keys in said SQL databases. Said relations, compositions and compilations can be viewed by Dr. Doe and his related health-care buyers whose number can be adjusted and varied by and among Dr. Doe and his related health-care buyers.

Said one preferred embodiment—represented supra by said Evaluations categories—is applicable to said any and all medical and surgical words, terms, phrases and sentences in said categories of, but not limited to, Laboratories, Imaging, Body Fluid Tests and Tissues Examinations, Medications, Devices, Equipment, Procedures, Treatments, Surgeries, Recommendations, Guidelines, Advises and Referrals and related individual fixed or non-negotiable costs, rates or charges being generated by said individual physicians, groups of physicians, hospitals, health-care clinics facilities or departments or their staff as represented by said Dr. Doe. The plurality of number of interactive boxes in each said page corresponds to the number of individual medical and surgical words, terms, phrases and sentences in each category in individual medical or surgical specialties or practices of said individual physicians, groups of physicians, hospitals, health-care clinics, facilities or departments.

Furthermore, not illustrated supra, said Editions on individual costs, rates and charges related to medical and surgical words, terms, phrases and sentences in each and every said category can be subsequently, independently and individually adjusted and reset by individual providers or their staff.

Second, further to supra, another of the innovative and unique preferred embodiments of the present invention, said adaptable interactive linked Web pages and electronic templates and linked numerous interactive pop-up and drop-down lists are adaptable to computer-automatically generate a plurality of components of said computerized system for generating individual relations, compositions and compilations of negotiable, variable, adjustable and set or agreed individual costs, rates or charges of said individual health and health-care services, goods, equipment, medications, drugs and pharmaceuticals by and between said individual health-care providers and individual health-care buyers in anywhere and different and diverse localities. In this preferred embodiment, said groups of physicians apply to physicians in various practice settings and circumstances in the same, anywhere or different and diverse localities as represent by one preferred embodiment infra.

In this one of the innovative and unique preferred embodiments of the present invention, in said network or networks and said platforms, there are successive and sequential asking, bidding and negotiations of negotiable, variable, adjustable and set or agreed individual costs, rates or charges of said individual health and health-care services, goods, equipment, medications, drugs and pharmaceuticals—going back and forth in said computers, laptops and devices in said network or networks and, better yet, in said teleconferencing platforms—by and between said individual providers or their staff and related individual health-care buyers or their staff in anywhere and different and diverse localities.

### Dr. James Arrowsmith (JA) and Related Demographic Information and Data

### Related Health-Care Buyers and Related Demographic Information and Data

Evaluations Laboratories Imaging Body Fluid Tests and Tissues
Examinations Medications Devices Equipment Procedures Treatments
Surgeries Recommendations Guidelines Advises Referrals

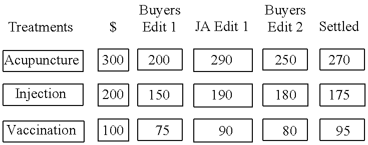

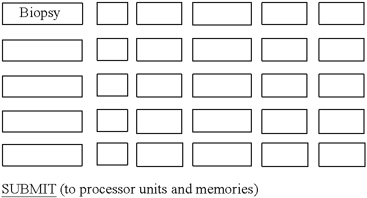

Further to supra, one of the innovative and unique preferred embodiments of the present invention, said adaptable interactive linked Web pages and electronic templates and linked numerous interactive pop-up and drop-down lists are adaptable to computer-automatically and continually retrieve and display on said viewing screens a second plurality of components of said computerized system for generating individual relations, compositions and compilations of negotiable, variable, adjustable and agreed or set or settled individual costs, rates or charges of individual health and health-care services, goods, equipment and medications related to and between said individual providers and buyers related to said consumers in said processor units, memories and SQL databases. The number of said health-care buyers can vary from one individual health-care buyer to many individual health-care buyers related to health-care consumers related to said fictitious Dr. Arrowsmith—representing said individual health-care providers or their staff in anywhere and different and diverse localities.

In said schematic one page comprising information and data on said fictitious Dr. James Arrowsmith, M.D., as shown supra, prompted said servers to display said schematics in said adaptable interactive linked Web pages and electronic templates and said plurality of linked interactive categories for selecting, clicking, retrieving and displaying all items and related compositions and compilations in said SQL databases in said representative schematics in said viewing screens of said computers, laptops, mobile and wireless communication devices and, teleconferencing devices being used by said Dr. Arrowsmith.

Having selected and clicked said interactive Treatments category—which was Treatments prior to said selecting and clicking—by Dr. Arrowsmith to retrieve relations, compositions and compilations of related information and data in said Treatments category from said processor units, memories and SQL databases to show said columns and rows of interactive boxes. Schematically, said first three boxes in said first column under said Treatments heading schematically representing variable number of items ranging from several treatments to tens of treatments in different medical specialties or practices—not shown in said representation supra—briefly represented supra by said Acupuncture, Injection, Vaccination and biopsy—which are computer-automatically generated from said processor units, memories and information and data on said category in said SQL databases and retrieved and displayed in said viewing screens. Subsequently, said $300, $200 and $100—without the redundant Cents column in this brief illustration—in said three interactive boxes in said second column under said $ heading—representing the negotiable, variable or adjustable asking costs, rates or charges of Acupuncture, Injection and Vaccination, respectively, generated or keyboarded into said interactive boxes by said Dr. Arrowsmith. Dr. Arrowsmith can complete his negotiable, variable or adjustable asking costs, rates or charges for all said treatments related to him and click said interactive SUBMIT to input said relations and compositions related to him to said processor units, memories and SQL databases. Said relations, compositions and compilations in said SQL databases related to Dr. Arrowsmith can be retrieved and viewed in said viewing screens and platforms by Dr. Arrowsmith and his related health-care buyers whose number can be adjusted and varied by and among Dr. Arrowsmith and his related individual health-care buyers. Dr. Arrowsmith can complete his negotiable, variable or adjustable asking costs, rates or charges for all said treatments related to him and click said interactive SUBMIT to input said relations and compositions related to him to said processor units, memories and SQL databases. Said relations, compositions and compilations in said SQL databases related to Dr. Arrowsmith can be retrieved and viewed in said viewing screens and platforms by Dr. Arrowsmith and his related health-care buyers whose number can be adjusted and varied by and among Dr. Arrowsmith and his related individual health-care buyers.

Consequently, said first relations, compositions and compilations in said SQL databases represented by said first and second column related to Dr. Arrowsmith can be retrieved, viewed and edited in said Web pages and templates in said viewing screens and platforms by said related individual health-care buyers or related health-care buyers using said column 3 represented by said Buyers Edit 1 in said Web pages and templates in said viewing screens of said computers, laptops, mobile and wireless communication devices, teleconferencing platforms in said network or networks from anywhere and different and diverse localities.

Consequently and repetitively, Dr. Arrowsmith can retrieve said relations, compositions and compilations and Buyers Edit 1 in said SQL databases and edit said relations, compositions and compilations in said Buyers Edit 1 SQL databases by keyboarding or generating different individual costs, rates or charges in each said interactive boxes in said column under JA Edit 1. In other words, said fictitious physician—representing individual physicians, groups of physicians, hospitals, health-care clinics, facilities or departments or their staff in anywhere and different and diverse localities—can achieve supra and also adjust and reset said relations, compositions and compilations of said individual costs, rates and charges related to individual health and health-care services, goods related to said individual buyers or buyers related to Dr. Arrowsmith.

In brief, said back and forth negotiations and each submissions to said processor units, memories and SQL databases, and as many times enabled and effected by the present invention albeit tedious for Dr. Arrowsmith or his staff, between Dr. Arrowsmith and said related said individual buyers or buyers as JA Edit 1 of said Buyers Edit 1 and, reciprocally as Buyers Edit 2 of said JA Edit 1. Finally, in said setting, said negotiations between Dr. Arrowsmith and said related said individual buyers or buyers are terminated by said Settled column representing established or set individual costs, rates and charges required by Dr. Arrowsmith.

Said one preferred embodiment—represented supra by said Treatments categories—is applicable to said any and all medical and surgical words, terms, phrases and sentences in said categories of, but not limited to, Evaluations, Laboratories, Imaging, Body Fluid Tests and Tissues Examinations, Medications, Devices, Equipment, Procedures, Surgeries, Recommendations, Guidelines, Advises and Referrals and related individual negotiable, variable, adjustable and agreed or set or settled individual costs, rates or charges of said individual health and health-care services, goods, equipment, medications, drugs and pharmaceuticals generated by said individual physicians, groups of physicians, hospitals, health-care clinics facilities or departments or their staff as represented by said fictitious Dr. Arrowsmith. The plurality of number of interactive boxes in each said page corresponds to the number of individual medical and surgical words, terms, phrases and sentences in each category in individual medical or surgical specialties or practices of said individual physicians, groups of physicians, hospitals, health-care clinics, facilities or departments.

Furthermore, not illustrated supra, said settled or set individual costs, rates and charges related to medical and surgical words, terms, phrases and sentences in each and every said category can be subsequently, independently and individually adjusted and reset by individual providers or their staff.

Further to supra, in other words, successive or sequential relations, compositions and compilations of individual said adjusted, negotiated, agreed and set costs, rates or charges related to said individual payable health-care and health-care services, goods, equipment and medications in said categories related to said individual health-care providers of diverse medical and surgical specialties and practices and related individual buyers in anywhere and different and diverse localities and related demographic information and data, using said related interactive boxes, are successively or sequentially adjusted, varied, negotiated, updated and adapted in said processor units, memories and SQL databases in and manage by said SQL Server in said servers in said network or networks.

Third, yet another one of the innovative and unique preferred embodiments of the present invention provides yet another innovative and unique method for successively or sequentially calculating, computing and mathematically manipulating and statistical analyzing said successive or sequential relations, compositions and compilations of said individual variable, adjustable, negotiated and agreed or set individual costs, rates or charges related to said individual health and health-care services, goods, equipment and medications related to said providers and related individual buyers and related demographic information and data. In other words, further to supra, said providers, for example, in specific demography and medical or surgical specialty or practice represented, but not limited to, herein by a zip code or a group zip codes in a region or locality and neurology, respectively, each of whom can be represented by individual said fictitious Dr. James Arrowsmiths. As illustrated supra using said Dr. James Arrowsmith, each said individual providers or said individual fictitious Dr. James Arrowsmiths can independently generate successive or sequential relations, compositions and compilations of individual said adjusted, negotiated, agreed and set costs, rates or charges related to said individual payable health-care and health-care services, goods, equipment and medications in said categories related to said individual health-care providers of diverse medical and surgical specialties and practices and related individual buyers in anywhere and different and diverse localities and related demographic information and data, using said related interactive boxes, are successively or sequentially adjusted, varied, negotiated, updated and adapted in said processor units, memories and SQL databases in and manage by said SQL Server in said servers in said network or networks. However, in this preferred embodiment, said relations, compositions and compilations in individual independent generations are computer-automatically pooled and calculated, computed and statistically analyzed. In other words, generations of averages, means or medians of said first pooled relations, compositions and compilations in individual categories generated and submitted by all said individual fictitious Dr. James Arrowsmiths who are surgeons in said zip code or a group zip codes in a region or locality representing one of the simplest computer-automatic calculations.

### Health-Care Providers and Related Demographic Information and Data

### Related Health-Care Buyers and Related Demographic Information and Data

Evaluations Laboratories Imaging Body Fluid Tests and Tissues
Examinations Medications Devices Equipment Procedures Treatments
Surgeries Recommendations Guidelines Advises Referrals

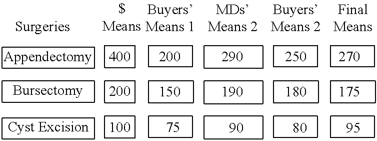

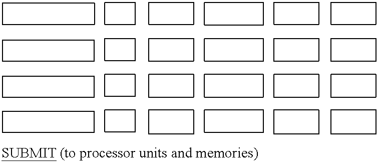

In said illustration, having selected and clicked said interactive Treatments category—which was Surgeries prior to said selecting and clicking—by said individual fictitious Dr. James Arrowsmiths to independently retrieve relations, compositions and compilations of related information and data in said Surgeries category from said processor units, memories and SQL databases to show said columns and rows of interactive boxes. Schematically, said first three boxes in said first column under said Surgeries heading schematically representing variable number of items ranging from several surgical procedures to tens of surgical procedures in different surgical specialties or practices—not shown in said representation supra—briefly represented supra by said Appendectomy, Bursectomy and Excision—which are computer-automatically generated from said processor units, memories and information and data on said category in said SQL databases and retrieved and displayed in said viewing screens. Subsequently, said $400, $200 and $100—without the redundant Cents column in this brief illustration—in said three interactive boxes in said second column under said $ heading—representing the negotiable, variable or adjustable mean asking costs, rates or charges of Appendectomy, Bursectomy and Excision, respectively, generated or keyboarded into said interactive boxes by said individual fictitious Dr. James Arrowsmiths and are the mathematical products of said generations of averages—or means or medians of said first pooled relations, compositions and compilations in individual Surgeries categories generated and submitted by all said individual fictitious Dr. James Arrowsmiths who are surgeons in said zip code or a group zip codes in a region or locality representing one of the simplest computer-automatic calculations. The asking costs or prices of said surgeons in said zip code or a group zip codes in a region or locality is schematically represented by the averages produced by the computer-automatic calculations in said processor units and memories:

In a mathematical expression of all possible mathematical calculations of $ Means: $ Means for Appendectomy=Σ fees or charges for Appendectomy of all surgeons in said zip code or a group zip codes in a region or locality÷ the number of said surgeons=$ Means=$400

In a mathematical expression of all possible mathematical calculations of $ Means: $ Means for Bursectomy=Σ All fees or charges for Bursectomy of all surgeons in said zip code or a group zip codes in a region or locality÷the number of said surgeons=$ Means=$200

In a mathematical expression of all possible mathematical calculations of $ Means: $ Means for Cyst Excision=Σ All fees or charges for Cyst Excision of all surgeons in said zip code or a group zip codes in a region or locality÷the number of said surgeons=$ Means=$100

Consequently, said Mean $ in said relations, compositions and compilations in said SQL databases represented by said first column related to said individual fictitious Dr. James Arrowsmiths are computer-automatically retrieved from said processor units, memories and SQL databases and viewed in said viewing screens and, using said interactive boxes in said Web pages and templates in said viewing screens or platforms—not represented supra—by independent said related individual buyers to collectively but independently negotiated by said related individual health-care buyers in said zip code or a group zip codes in a region or locality. Similar to supra, said third column under Buyers' Mean 1 schematically represents the mathematical products of said generations of averages—or means or medians of said first pooled relations, compositions and compilations—generated by independent individual buyers responding to said Mean $ representing one of the simplest computer-automatic calculations of said calculations of said pooled relations, compositions and compilations generated by said buyers. The counter offers or bids by said related buyers in said zip code or a group zip codes in a region or locality is schematically represented by the averages produced by the computer-automatic calculations in said processor units and memories:

In a mathematical expression of all possible mathematical calculations of Buyers' Mean 1: Buyers' Means 1 for Appendectomy=Σ All negotiated payments or bids for Appendectomy of all buyers in said zip code or a group zip codes in a region or locality as said surgeons÷ the number of said related buyers=Buyers' Mean 1=$200

In a mathematical expression of all possible mathematical calculations of Buyers' Mean 1: Buyers' Mean 1 for Bursectomy=Σ All negotiated payments or bids for Bursectomy of all buyers in said zip code or a group zip codes in a region or locality as said surgeons÷ the number of said related buyers=Buyers' Mean 1=$150

In a mathematical expression of all possible mathematical calculations of Buyers' Mean 1:

Buyers' Mean 1 for Cyst Excision=Σ All negotiated payments or bids for Cyst Excision of all buyers in said zip code or a group zip codes in a region or locality as said surgeons÷ the number of said buyers=Buyers' Mean 1=$75

As the counters to said Buyers' Mean 1, said surgeons' counters represented by said MDs' Mean 2 is schematically represented by the averages produced by the computer-automatic calculations in said processor units and memories:

In a mathematical expression of all possible mathematical calculations of MDs' Mean 2: MDs' Mean 2 for Appendectomy=Σ All counter asking prices for Appendectomy of all surgeons in said zip code or a group zip codes in a region or locality÷ the number of said surgeons=MDs' Mean 2=$290

In a mathematical expression of all possible mathematical calculations of MDs' Mean 2: MDs' Mean 2 for Bursectomy=Σ All counter asking prices for Bursectomy of all surgeons in said zip code or a group zip codes in a region or locality÷ the number of said surgeons=MDs' Mean 2=$190

In a mathematical expression of all possible mathematical calculations of MDs' Mean 2: MDs' Mean 2 for Cyst Excision=Σ All counter asking prices for Cyst Excision of all buyers in said zip code or a group zip codes in a region or locality÷ the number of said surgeons=MDs' Mean 2=$90

In brief, said fourth and fifth columns in said Surgeries category under Buyers' Mean 2 and Final Means, respectively, represent same logics supra and outcomes of said computer-automatic calculations of said pooled relations, compositions and compilations of further back-and-forth negotiations between more, less or same number of said providers and more, less or same said related buyers using said interactive boxes in said Web pages and templates in said viewing screens or platforms—not represented supra—to collectively but independently negotiate to generate said calculations for each and every items in said columns.

Said Means Represent the Averages in Said Settings.

Said one preferred embodiment—represented supra by said surgical words, terms, phrases and sentences in the Surgeries categories—is applicable to said any and all medical and surgical words, terms, phrases and sentences in said categories of, but not limited to, Evaluations, Laboratories, Imaging, Body Fluid Tests and Tissues Examinations, Medications, Devices, Equipment, Procedures, Treatments, Recommendations, Guidelines, Advises and Referrals and related individual negotiable, variable, adjustable and agreed or set or settled individual costs, rates or charges of said individual health and health-care services, goods, equipment, medications, drugs and pharmaceuticals generated by said physicians representing groups of physicians, hospitals, health-care clinics facilities or departments. The plurality of number of interactive boxes in each said page corresponds to the number of individual medical and surgical words, terms, phrases and sentences in each category in individual medical or surgical specialties or practices of said physicians or groups of physicians, hospitals, health-care clinics, facilities or departments.

Furthermore, not illustrated supra, said Final Means represent settled or set individual costs, rates and charges related to medical and surgical words, terms, phrases and sentences in each and every said category can be subsequently, independently and individually adjusted and reset by individual providers or their staff.

If effected by said individual providers, the present invention further provides a method for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers in interactive boxes for enabling, adjusting, updating and adapting said individual costs, rates or charges related to said individual providers and related said individual buyers.

Uniquely in said network or networks, said providers and related buyers and related demographic information and data represented by said preferred embodiments are among many innovative and unique preferred embodiments of the present invention generated and effected numerous said components of said computerized system related to said individual providers and individual buyers and related demographic information and data in said processor units, memories and SQL databases in and manage by said SQL Server.

For example among many, another one of the innovative and unique preferred embodiments of the present invention provides for a method for setting and resetting or switching the applications of said components of said computerized system in said functioning and operating computerized systems of payments and related disbursements and barters in said servers by said individual providers comprises a process for continually selecting and applying any said component or any combinations of said components of said computerized system for generating individual fixed or non-negotiable costs, rates or charges and for generating negotiable, variable, adjustable and agreed or set individual costs, rates or charges in said functioning and operating computerized systems of payments and related disbursements and barters in said servers.

In other words, in numerous settings and circumstances related to thousands of said health-care providers in said about 85 medical and surgical specialties or practices, for example, a representative neurologist may use said fixed prices with certain one or a plurality of individual health-care buyers and said negotiable with other one or other plurality of individual health-care buyers. While, a representative endocrinologist may use said fixed prices with certain one or a plurality of individual health-care buyers and said negotiable with other one or other plurality of individual health-care buyers. While, a representative neurosurgeon may use said fixed prices with said individual health-care buyers. While a representative general practitioner may use said fixed prices with certain one or a plurality of individual health-care buyers and said negotiable with other one or other plurality of individual health-care buyers. Said preferred embodiments can be independently achieved by said health-care providers in diverse and different settings and circumstances and locations in America and other nations on earth in said network or networks.

In yet other words, said individual providers can choose and use one or a plurality of said components of said computerized system in said functioning and operating computerized systems of payments and related disbursements and barters in said servers. Subsequently, said individual providers can switch to use another one or different combinations or plurality of said components of said computerized system in said functioning and operating computerized systems of payments and related disbursements and barters in said servers. Furthermore, yet another example of said preferred embodiment, a rheumatologist, for example, who practiced in a certain zip code, say of a town in Virginia, and used one or a plurality of said components related to rheumatologists related to said certain zip code and said rheumatologist relocated to another practice in a different or new zip code, say of a town in New York State, can switch to use another one or different combinations or plurality of said components of said computerized system peculiar or related to said new zip code in said town in New York State related to said rheumatologists in said new zip code in said town in New York. Concurrently, said information and data on said rheumatologist are instantly posted to related health-care buyers and consumers.

Said preferred embodiments can be independently achieved by said health-care providers in diverse and different settings and circumstances and locations in America and other nations on earth in said network or networks.

Furthermore, said preferred embodiments of the present invention are applicable to said barters since individual non-health and non-health-care goods and services provided by said individual buyers and consumers are related to individual prices, monetary values or costs which are related to said individual costs, rates or charges, said individual providers.

Said preferred embodiments and their derivatives are applicable to and for all health-care providers and related health-care buyers and consumers in America and other nations on earth and have taken diverse and different currencies, goods and services and exchanges into considerations and executions in said network or networks.

It is to be understood that said computerized system for generating individual fixed or non-negotiable costs, rates or charges of individual health and health-care services, goods, equipment and medications represented by individual words, terms, phrases and sentences in individual medical and surgical categories by physicians, individual physicians, individual groups of physicians, individual hospitals, individual health-care clinics, individual health-care facilities or individual departments and for generating negotiable, variable, adjustable and set or agreed individual costs, rates or charges of said individual health and health-care services, goods, equipment and medications by and between physicians, individual physicians, individual groups of physicians, individual hospitals, individual health-care clinics, individual health-care facilities or individual departments and health-care buyers, individual health-care buyers, individual groups of health-care buyers, individual consumers, individual groups of consumers or individual governments and related preferred embodiments and examples are computer-automatically and continually apply and effected in about 85 medical and surgical specialties or practices in said in network or networks of said servers, computers, laptops, mobile and wireless communication devices, teleconferencing platforms and the Internet being used by said buyers and providers, enabled and effected by and according to said innovative computer programs and software and stored procedures. Only in said servers, this vast and extremely extensive and complex preferred embodiments—briefly represented supra—are achieved for all individual fixed or nonnegotiable and negotiable, adjusted, variable, agreed and set costs, rates or charges related to said individual payable health-care and health-care services, goods, equipment and medications in all said categories in about 85 medical and surgical specialties, practices in various said settings, circumstances, locations and practices and said individual providers and individual buyers and consumers and related demographic information and data, enabled and effected by said innovative computer programs and software and stored procedures coupled to said processor units and memories.

Furthermore, the present invention provides, selected, clicked or prompted by said individual providers a method for setting and resetting or switching the applications of said components of said computerized system in said functioning and operating computerized systems of payments and related disbursements and barters in said servers by said individual providers comprises a process for continually selecting and applying any said component or any combinations of said components of said computerized system for generating individual fixed or non-negotiable costs, rates or charges and for generating negotiable, variable, adjustable and agreed or set individual costs, rates or charges in said functioning and operating computerized systems of payments and related disbursements and barters in said servers to be suit the needs and requirements of said individual buyers.

Said preferred embodiments and their derivatives of the present invention involve and use appropriate, practical and effective mathematical formulas, equations, calculations, actuaries, statistics such as, but not limited, to sums, averages, means, medians, standard deviations, variances and mathematical and graphic illustrations, analyses, representations and displays commonly applied and used in sciences, medicine, health, health-care and health-care services and information and data on said individual buyers and individual providers from the Internal Revenue Service and from said individual buyers and individual providers and related demographic information and data, enabled and effected by said innovative computer programs and software and stored procedures coupled to said processor units and memories wherein said mathematical calculations, manipulations and statistical analyses are performed and their adaptations, variations and derivatives to achieve the objectives and goals of the present invention.

Said calculations and mathematical manipulations and components of the present invention involved processes in said processor units, memories and SQL databases in and manage by said SQL Server coupled to and commanded, enabled and effected by and according to said innovative computer programs and software and stored procedures.

With said prototype of the present invention, said preferred embodiments and their derivatives of the present invention are computer-automatically and continually implemented and served in the functioning and operating computerized systems of payments and related disbursements and barters in a functioning and operating computer server or servers in said pending patent applications such as, but not limited to, Ser. No. 12/592,714 filed Dec. 2, 2009 entitled Health-care Exchange IV, Ser. No. 12/584,718 filed Sep. 11, 2009 entitled the Health-care exchange III, Ser. No. 12/381,654 entitled the Adaptable Compositions of Health Information, Ser. No. 12/321,141 entitled the Best system of health and health-care data management Ser. No. 12/069,409 entitled the Filing of health and health-care data, Ser. No. 12/322,529 entitled the Healthcare exchange II, Ser. No. 12/080,433 filed Apr. 3, 2008 entitled Healthcare exchange, Ser. No. 12/072,097 filed Feb. 25, 2008 entitled a Method of empowering owners of health-care resources, and Ser. No. 11/242,461 filed Oct. 4, 2005 entitled a Perfect system of compensations for physicians for managing, effecting and controlling said costs, expenses, payments, compensations and revenues of, by and among said buyers and related providers in a functioning and operating servers in a network or networks of said servers, computers, laptops, mobile and wireless communication devices, teleconferencing platforms and the Internet being used by said buyers and providers, enabled and effected by and according to said innovative computer programs and software and stored procedures.

It is understood that the terms health-care, health care and healthcare have the same meaning and application and that the terms computer server and server have the same meaning and application. Also, it is understood that the term software is used herein as singular and pleural.

It is to be understood that said preferred embodiments and examples apply to physicians and information and data on diseases and disorders in about 85 medical and surgical specialties or practices.

Although it has been described in pending earlier patent applications, said data and information are words, terms, word and term headers and topics and subjects as shown above such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe and document data and information on diseases, illnesses, disorders, health and health-care of patients and health-care services. At least Java Script and AJAX are used to support said templates, lists and menus.

The method, processes, system, protocols, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages and server operating systems such as, but not limited to, those made and sold by Microsoft Corporation such as, but not limited to, Microsoft Windows Server 2008 and their derivatives, and by nascent computer operating system by Google, and SQL such as, but not limited to Microsoft SQL Server 2008 R2 and derivatives, MySQL and the like, Internet Explorer, Web browsers, Web server, Apache, Microsoft IIS, Visual Studio and .Net, Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP 5.2.14 and the like and derivatives, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

Applying and using teleconferencing technologies and platforms and their derivatives in said network or networks of computer servers, computers, laptops and mobile and wireless communication and teleconferencing-enabled devices, the preferred embodiments of the present invention are applied and used by health-care buyers, individual health-care buyers or individual groups of health-care buyers, consumers and governments and physicians, individual physicians or individual groups of physicians, hospitals and health-care facilities and their employees and staff members in same and diverse and different settings and locations and all different time zones all over the world. In other words, the preferred embodiments of the present invention can be and are enabled and effected by numerous commercially available teleconferencing technologies and products provided by, but not limited to, www.webex.com by Cisco Systems, Inc., www.gotomeeting.com by Citrix Online, L.L.C., Microsoft Office Live Meeting by Microsoft Corporation and Adobe Acrobat Connect by Adobe Systems, Inc. and their derivatives and the like, and various companies or corporations to enable said individuals in various and different settings and locations to teleconference, effect and use said preferred embodiments in said network or networks via the Internet to achieve the goals and objectives of the present invention.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related and their derivatives, and various equipment including modems sold, lease, own and operate by cable companies such as, but not limited to, Time Warner and Optimum Online in New York, etc. Further to supra, currently, various server blades and various hardware and equipment configurations, virtual servers such as those sold by VMware, HP and IBM, and their derivatives being used by many large American corporations are set up and implemented for implementing said pending patents and the present invention. HP servers—see www.hp.com for details of the server hardware and internal design—and similar Dell servers—see www.dell.com for details of the server hardware and internal design—used by the present patent applicant as the hardware wherein the computer programs and software(s) mentioned herein operated. It is to be understood that said pending patents and related applications and the present invention enabled and effected by said equipment, devices, computer programs and software and technologies birthed said Cloud Healthcare Exchange for achieving and fulfilling said goals and objectives, enterprises and endeavors in said pending patents and the present invention.

It is to be understood that physicians, individual physicians, individual groups of physicians, hospitals and health-care facilities described herein also included all health, health-care, health-care providers providing health, health-care, health-care services and supports and manufacturers, producers, companies and corporations and sellers of medications, drugs and pharmaceuticals related to people. Furthermore, individual health-care buyers and consumers represent, but not limited to, individual companies, corporations, employers, businesses, operations, various municipalities, cities, towns, states, organizations, entities, departments, institutions and patients purchasing, using and consuming said health, health-care and health-care services and goods, equipment, medications and pharmaceuticals for their employees, retirees and their dependents or for themselves. Said governments represent governments of any and all nations in the world.

It is to be understood that said preferred embodiments of the present invention involve and use appropriate, practical and effective mathematical formulas, equations, calculations, actuaries, statistics such as, but not limited, to sums, averages, means, medians, standard deviations, variances and mathematical and graphic illustrations, analyses, representations and displays commonly applied and used in sciences, medicine, health, health-care and health-care services and information and data on said individual buyers and individual providers from the Internal Revenue Service and from said individual buyers and individual providers and related demographic information and data, enabled and effected by said innovative computer programs and software and stored procedures coupled to said processor units and memories wherein said mathematical calculations, manipulations and statistical analyses are performed and their adaptations, variations and derivatives to achieve the objectives and goals within the spirit and the scope of the claims of the present invention.

It is to be understood that one of the preferred embodiments of the present invention teaches said keyboarding and interactive boxes in said viewing screens, it will be appreciated by those skilled in the art that their adaptations, variations and derivatives including voice inputs and related speech recognition technologies and devices may be applied and engaged to achieve the objectives and goals of the present invention without departing from the spirit and the scope of the claims of the present invention.

Although various preferred embodiments of the present invention have been described, it will be appreciated by those skilled in the art that their adaptations including various combinations of said preferred embodiments and variations, expansions and derivatives may be made to achieve the objectives and goals of the present invention without departing from the spirit and the scope of the claims of the present invention.

1. A computerized system for generating individual fixed or non-negotiable costs, rates or charges of individual health and health-care services, goods, equipment and medications represented by individual words, terms, phrases and sentences in individual medical and surgical categories by physicians, individual physicians, individual groups of physicians, individual hospitals, individual health-care clinics, individual health-care facilities or individual departments henceforth collectively known as individual providers and for generating negotiable, variable, adjustable and set or agreed individual costs, rates or charges of said individual health and health-care services, goods, equipment and medications by and between individual providers and individual health-care buyers, individual groups of health-care buyers, individual consumers, individual groups of consumers or individual governments henceforth collectively known as individual buyers for implementing and serving in the functioning and operating computerized systems of payments and related disbursements and barters resulting in individual varied and adjusted health-care costs and expenses and related individual payments, compensations and revenues of, by and between said individual buyers and related said individual providers for managing, effecting and controlling said costs, expenses, payments, compensations and revenues of, by and among said individual buyers and related individual providers in a functioning and operating computer server or servers henceforth servers in a network or networks of said servers, computers, laptops, mobile and wireless communication devices, teleconferencing platforms and the Internet being used by said buyers and providers comprises:
said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and innovative computer programs and software coupled to, communicating with and commanding said SQL Server, processor units and memories, adaptable interactive linked Web pages and electronic templates and numerous linked interactive pop-up and drop-down lists in said viewing screens, a plurality of components of said computerized system and functioning and operating computerized systems of payments and related disbursements and barters, teleconferencing technologies and related devices and equipment, said computers, laptops and devices comprising keyboards and viewing screens including touch-enabled viewing screens or touchscreens, enabled by Web browsers and said Web server, for continually accessing and managing SQL databases in and manage by said SQL Server and using said systems by said buyers and providers in said network or networks;
said adaptable and expanding SQL databases in and managed by said SQL Server comprising:
i) relations, compositions and compilations of said individual words, terms, phrases and sentences, which are integral components of said health, health-care and health-care-service information and data on or relating to diseases and disorders and patients used and use by physicians of all and diverse medical and surgical practices or specialties for and in the communications of said information and data among and between physicians and between physicians and patient, representing individual payable health-care and health-care services in said medical and surgical categories of Evaluations, Laboratories, Imaging, Body Fluid Tests and Tissues Examinations, Medications, Devices, Equipment, Procedures, Treatments, Surgeries, Recommendations, Guidelines, Referrals, related to individual diagnoses or individual diagnoses in individual groups of same, equivalent or similar diagnoses of diseases and disorders, and related individual prices, monetary values or costs and related fixed or non-negotiable costs, rates and charges and variable, adjusted and set individual costs, rates and charges related to said individual buyers and individual providers and said demographic information and data on said individual providers and individual buyers related to individual health-care consumers and related individual SQL keys;
ii) successive relations, compositions and compilations of said individual words, terms, phrases and sentences representing said individual payable health-care and health-care services in said categories and successive variable, adjusted and set individual costs, rates and charges and related said individual buyers and individual providers, said demographic information and data on said individual providers and individual buyers and individual health-care consumers and related SQL keys;
iii) individual non-health and non-health-care goods and services and related individual monetary values assigned to said individual non-health and non-health-care goods and services related to individual SQL keys;
iv) individual relations, compositions and compilations of individual monetary values related to individual non-health-care services and goods represented by individual texts, numbers, graphics, illustrations related to said individual buyers and related SQL keys;
v) individual relations, compositions and compilations of said fixed or non-negotiable costs, rates or charges of individual health and health-care services, goods, equipment and medications related to said individual providers and related demographic information and data on said individual providers and related SQL keys;
vi) individual relations, compositions and compilations of successive or sequential individual variable, adjustable, negotiated and agreed or set individual costs, rates or charges related to said individual health and health-care services, goods, equipment and medications by and between individual providers and individual health-care buyers and consumers and related demographic information and data and related SQL keys;
vii) successive or sequential mathematical calculations, computations and statistical analyses, manipulations of said successive or sequential individual variable, adjustable, negotiated and agreed or set individual costs, rates or charges related to said individual payable health-care and health-care services, goods, equipment and medications and related to said individual providers, individual health-care buyers and consumers and related demographic information and data and related SQL keys; and
viii) adjusted and reset relations, compositions and compilations of said individual costs, rates and charges related to individual health and health-care services, goods, said individual providers and related SQL keys;
said adaptable interactive linked Web pages and electronic templates and linked numerous interactive pop-up and drop-down lists for continually creating and generating in and retrieving from said processor units and memories and SQL databases, expressing, displaying and managing said non-negotiations, variations, adjustments, negotiations and sets of said costs, rates and charges of said plurality of components of computerized system in said viewing screens and computer-automatically and continually outputting said relations, compositions and compilations of said non-negotiations, variations, adjustments, negotiations and sets from said processor units and memories and SQL databases, enabled and effected by said JavaScript, AJAX, HTML, .net, Wordpad, Notepad, .txt programs, Web browsers and Web server, innovative computer programs and software and stored procedures and teleconferencing technologies and platforms;
said innovative computer programs and software and stored procedures for:
i) continually generating, retrieving and displaying said adaptable interactive linked Web pages and electronic templates and linked numerous interactive pop-up and drop-down lists in said viewing screens;
ii) generating said individual fixed or non-negotiable costs, rates or charges of individual health and health-care services, goods, equipment and medications by said individual providers and for negotiating, varying, adjusting and setting individual costs, rates or charges of said individual health and health-care services, goods, equipment and medications by and between said individual buyers and individual providers using said adaptable interactive linked Web pages and electronic templates and linked numerous interactive pop-up and drop-down lists in said viewing screens;
iii) continually and sequentially calculating, computing and applying statistical analyses and mathematically manipulating said successive or sequential individual variable, adjustable, negotiated and agreed or set individual costs, rates or charges generated, varied, adjusted and negotiated by and between said individual buyers and related individual providers related to said individual demographic information and data on individual buyers and providers in said processor units, memories and outputting said calculated and computed said individual costs, rates and charges to, to be related and compiled in said adaptable and expanding SQL databases;
iv) continually and sequentially retrieving and displaying said adaptable and expanding relations, compositions and compilations and related mathematical calculations, computations and statistical analyses, manipulations of said relations, compositions and compilations of said individual costs, rates and charges of said individual buyers and related said individual providers and related demographic information and data;
v) assigning individual monetary values to individual non-health and non-health-care goods and services using said adaptable interactive linked Web pages and electronic templates and linked numerous interactive pop-up and drop-down lists in said viewing screens and in said processor units and memories and outputting said relations to, to be related and compiled in said adaptable and expanding SQL databases;
vi) creating and generating said plurality of components of said computerized system for generating individual fixed or non-negotiable costs, rates or charges and for generating negotiable, variable, adjustable and set or agreed individual costs, rates or charges in said adaptable interactive linked Web pages and electronic templates, processor units and memories and SQL databases;
vii) adjusting and setting said individual costs, rates and charges of individual health and health-care services, goods, equipment and medications in said SQL databases by said individual providers;
viii) creating and generating, adapting and expanding said adaptable and expanding SQL databases in said processor units and memories and outputting said adaptable and expanding relations to, to be related by individual SQL keys and compiled with said adaptable and expanding relations, compositions and compilations in said adaptable and expanding SQL databases in and managed by said SQL Server; and
ix) implementing said plurality of components of said computerized system in said functioning and operating computerized systems of payments and related disbursements and barters in said servers; and
a plurality of components of said computerized system for generating individual fixed or non-negotiable costs, rates or charges and for generating negotiable, variable, adjustable and agreed or set individual costs, rates or charges generated in said adaptable interactive linked Web pages and electronic templates, processor units and memories and SQL databases in said adaptable interactive linked Web pages and electronic templates and linked numerous interactive pop-up and drop-down lists and said processor units, memories and SQL databases.

2. The computerized system for managing, effecting and controlling said costs, expenses, payments, compensations and revenues of, by and among said individual buyers and related individual providers according to claim 1 wherein said adaptable interactive linked Web pages and electronic templates and linked numerous interactive pop-up and drop-down lists comprises:
i) adaptable and expanding relations, compositions and compilations of said individual words, terms, phrases and sentences, which are integral components of said health, health-care and health-care-service information and data on or relating to diseases and disorders and patients used and use by physicians of all and diverse medical and surgical practices or specialties for and in the communications of said information and data among and between physicians and between physicians and patient, representing individual payable health-care and health-care services in said medical and surgical categories of Evaluations, Laboratories, Imaging, Body Fluid Tests and Tissues Examinations, Medications, Devices, Equipment, Procedures, Treatments, Surgeries, Recommendations, Guidelines, Referrals, related to individual diagnoses or individual diagnoses in individual groups of same, equivalent or similar diagnoses of diseases and disorders, and related individual prices, monetary values or costs and related individual buyers and individual providers and demographic information and data on said individual providers and individual buyers related to individual health-care consumers;
ii) individual relations of said fixed or non-negotiable costs, rates or charges of individual health and health-care services, goods, equipment and medications related to said individual providers, and demographic information and data on said individual providers and related interactive boxes for enabling, adjusting, updating and adapting said individual fixed or non-negotiable costs, rates or charges related to said individual providers in said processor units, memories and SQL databases, representing at least one of said plurality of components of said computerized system;
iii) successive or sequential relations, compositions and compilations of individual said adjusted, negotiated, agreed and set costs, rates or charges related to said individual payable health-care and health-care services, goods, equipment and medications in said categories and related individual buyers and related individual providers and consumers and related demographic information and data and related interactive boxes for successively or sequentially enabling, adjusting, varying, negotiating, updating and adapting said individual variable, adjustable, negotiable, agreed and set costs, rates or charges related to and between said individual providers and buyers related to said consumers in said processor units, memories and SQL databases; and
iv) computer-automatic and continual retrievals and displays of said adaptable and expanding relations, compositions and compilations and related mathematical calculations, computations and statistical analyses, manipulations of said relations, compositions and compilations of individual said adjusted, negotiated, agreed and set costs, rates or charges related to individual health and health-care services, goods, equipment and medications related to said individual buyers and related said individual providers and related demographic information and data in said processor units and memories and SQL databases; and
v) said interactive boxes for enabling, adjusting, updating and adapting said individual costs, rates and charges of said individual health and health-care services, goods, equipment and medications in said processor units, memories and SQL databases by and between said individual providers and related individual buyers.

3. The computerized system for managing, effecting and controlling said costs, expenses, payments, compensations and revenues of, by and among said individual buyers and related individual providers according to claim 1 wherein said plurality of components of said computerized system for generating individual fixed or non-negotiable costs, rates or charges and for generating negotiable, variable, adjustable and agreed or set individual costs, rates or charges generated in said adaptable interactive linked Web pages and electronic templates, processor units and memories and SQL databases in said adaptable interactive linked Web pages and electronic templates and linked numerous interactive pop-up and drop-down lists and said processor units, memories and SQL databases comprises:
i) individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers;
ii) successive or sequential relations, compositions and compilations of said individual variable, adjustable, negotiated and agreed or set individual costs, rates or charges related to said individual health and health-care services, goods, equipment and medications, by and between individual providers and related individual buyers related to individual health-care consumers, related to individual providers and related individual buyers and related demographic information and data;
iii) successive or sequential mathematical calculations, computations and manipulations and statistical analyses of said successive or sequential relations, compositions and compilations of said individual variable, adjustable, negotiated and agreed or set individual costs, rates or charges related to said individual health and health-care services, goods, equipment and medications, by and between individual providers and related individual buyers related to individual health-care consumers, related to said providers and related said buyers and related demographic information and data;
iv) adjusted and reset relations, compositions and compilations of said individual costs, rates and charges related to individual health and health-care services, goods, equipment and medications and related said individual providers.

4. The individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers according to claim 3 comprises:
assigned relations of related individual payable health and health-care services, goods, equipment and medications in said medical and surgical categories of Evaluations, Laboratories, Imaging, Body Fluid Tests and Tissues Examinations, Medications, Devices, Equipment, Procedures, Treatments, Surgeries, Recommendations, Guidelines, Referrals and individual fixed or non-negotiable costs, rates and charges related to said individual provider in said adaptable interactive linked Web pages and electronic templates and said processor units and memories and said SQL databases in and manage by said SQL Server,
assigned relations of related individual payable health and health-care services, goods, equipment and medications in said medical and surgical categories of Evaluations, Laboratories, Imaging, Body Fluid Tests and Tissues Examinations, Medications, Devices, Equipment, Procedures, Treatments, Surgeries, Recommendations, Guidelines, Referrals and individual fixed or non-negotiable costs, rates and charges generated in said interactive boxes for keyboarding said fixed or non-negotiable costs, rates and charges related to said individual providers in said adaptable interactive linked Web pages and electronic templates and said processor units and memories and said SQL databases in and manage by said SQL Server; and
related interactive boxes for keyboarding, adjusting, updating, adapting and resetting said individual costs, rates or charges related to said individual payable health and health-care services, goods, equipment and medications in said relations, compositions and compilations in said in said adaptable interactive linked Web pages and electronic templates in said viewing screens, said processor units, memories and SQL databases by said individual providers.

5. The successive or sequential individual variable, adjustable, negotiated and agreed or set individual costs, rates or charges related to said individual health and health-care services, goods, equipment and medications, by and between individual providers and related individual buyers related to individual health-care consumers, related to individual providers and related individual buyers and related demographic information and data in said processor units, memories and SQL databases according to claim 3 comprises:
assigned relations, compositions and compilations of said individual variable, adjustable, negotiable asking rates and charges and related said individual payable health and health-care services, goods, equipment and medications related to said individual providers, generated in said adaptable interactive linked Web pages and electronic templates in said viewing screens by said individual providers; and, sequentially and reciprocally,
said assigned relations, compositions and compilations of said individual variable, adjustable, negotiable asking rates and charges related to said individual providers and subsequent and related individual reciprocally different or edited negotiated said individual costs, rates and charges generated in said adaptable interactive linked Web pages and electronic templates in said viewing screens by said individual buyers; and, sequentially,
successive or sequential versions or series of said adaptable and expanding relations, compositions and compilations comprising said individual variable, adjustable, negotiated and agreed or set individual costs, rates or charges related to said individual health and health-care services, goods, equipment and medications, by and between said individual providers and related said individual buyers, related to said individual providers and related said individual buyers in successive or sequential said adaptable interactive linked Web pages and electronic templates in said viewing screens, processor units, memories and SQL databases in and manage by said SQL Server;
adjusted and reset relations of said individual costs, rates and charges of individual health and health-care services, goods, equipment and medications in interactive linked Web pages and electronic templates, processor units and memories and SQL databases, by said individual providers, and related said individual providers;
related interactive boxes for keyboarding or generating said relations, compositions and compilations in said successive or sequential said adaptable interactive linked Web pages and electronic templates in said viewing screens, processor units, memories and SQL databases by and between said individual providers and related individual buyers.

6. The successive or sequential mathematical calculations, computations and manipulations and statistical analyses of said successive or sequential relations, compositions and compilations of said individual variable, adjustable, negotiated and agreed or set individual costs, rates or charges related to said individual health and health-care services, goods, equipment and medications, by and between individual providers and related individual buyers related to individual health-care consumers, related to said providers and related said buyers and related demographic information and data according to claim 3 comprises:
said successive or sequential individual variable, adjustable, negotiated and agreed or set individual costs, rates or charges related to said individual health and health-care services, goods, equipment and medications, by and between individual providers and related individual buyers related to individual health-care consumers, related to individual providers and related individual buyers and related demographic information and data in said processor units, memories and SQL databases;
computer-automatic, sequential and continual calculations, computations and compilations and statistical analyses of said assigned relations, compositions and compilations of said individual variable, adjustable, negotiable asking and different or edited rates and charges and related said individual payable health and health-care services, goods, equipment and medications generated by and between and related to said providers and related said buyers and related demographic information and data in said processor units and memories and adaptable and expanding SQL databases in and manage by said SQL Server; and, sequentially,
computer-automatic, sequential and continual calculations, computations and compilations and statistical analyses of said successive or sequential versions or series of said adaptable and expanding relations, compositions and compilations comprising said individual variable, adjustable, negotiable asking and different or edited, agreed and set individual costs, rates or charges related to said individual health and health-care services, goods, equipment and medications, by and between said individual providers and related said individual buyers, related to said providers and related said buyers and related demographic information and data in successive or sequential said adaptable interactive linked Web pages and electronic templates in said viewing screens, processor units, memories and SQL databases in and manage by said SQL Server; and, sequentially,
related interactive boxes for keyboarding, adjusting, updating, adapting and resetting said adaptable and expanding relations, compositions and compilations in said adaptable interactive linked Web pages and electronic templates in said viewing screens, said processor units, memories and SQL databases by and between said individual providers and related individual buyers.

7. The computerized system according to claim 1 wherein said computer-automatic implementations of said plurality of components of said computerized system in said functioning and operating computerized systems of payments and related disbursements and barters in said servers comprises:
computer-automatic and continual implementations individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers;
computer-automatic and continual implementations of said successive or sequential individual variable, adjustable, negotiated and agreed or set individual costs, rates or charges related to said individual health and health-care services, goods, equipment and medications, by and between individual providers and related individual buyers related to individual health-care consumers, related to individual providers and related individual buyers and related demographic information and data in said processor units, memories and SQL databases;
computer-automatic and continual implementations of said computer-automatic, sequential and continual calculations, computations and compilations and statistical analyses of said successive or sequential versions or series of said adaptable and expanding relations, compositions and compilations comprising said individual variable, adjustable, negotiable asking and different or edited, agreed and set individual costs, rates or charges related to said individual health and health-care services, goods, equipment and medications, by and between said individual providers and related said individual buyers, related to said providers and related said buyers and related demographic information and data; and
computer-automatic and continual implementations of said individual adjusted, updated, adapted and reset said relations, compositions and compilations in said processor units and memories.

8. In a computerized system for generating individual fixed or non-negotiable costs, rates or charges of individual health and health-care services, goods, equipment and medications represented by individual words, terms, phrases and sentences in individual medical and surgical categories by physicians, individual physicians, individual groups of physicians, individual hospitals, individual health-care clinics, individual health-care facilities or individual departments henceforth collectively known as individual providers and for generating negotiable, variable, adjustable and set or agreed individual costs, rates or charges of said individual health and health-care services, goods, equipment and medications by and between individual providers and individual health-care buyers, individual groups of health-care buyers, individual consumers, individual groups of consumers or individual governments henceforth collectively known as individual buyers for implementing and serving in the functioning and operating computerized systems of payments and related disbursements and barters resulting in individual varied and adjusted health-care costs and expenses and related individual payments, compensations and revenues of, by and between said individual buyers and related said individual providers for managing, effecting and controlling said costs, expenses, payments, compensations and revenues of, by and among said individual buyers and related individual providers in a functioning and operating computer server or servers henceforth servers in a network or networks of said servers, computers, laptops, mobile and wireless communication devices, teleconferencing platforms and the Internet being used by said buyers and providers, a method for setting said individual fixed or non-negotiable costs, rates and charges of individual health and health-care services, goods, equipment and medications by individual providers and for negotiating, varying, adjusting and setting said individual costs, rates and charges by and between said individual providers and related individual buyers for varying, adjusting and discounting individual costs and expenses and payments, compensations and revenues related to said costs, rates and charges of, by and between said individual buyers and related individual providers for managing, effecting and controlling said costs, expenses, payments, compensations and revenues of, by and among said individual buyers and related individual providers in said computerized systems in said servers in said network or networks comprises:
a process for operating and applying said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and innovative computer programs and software coupled to, communicating with and commanding said SQL Server, processor units and memories, adaptable interactive linked Web pages and electronic templates and numerous linked interactive pop-up and drop-down lists in said viewing screens, a plurality of components of said computerized system and functioning and operating computerized systems of payments and related disbursements and barters, teleconferencing technologies and related devices and equipment, said computers, laptops and devices comprising keyboards and viewing screens including touch-enabled viewing screens or touchscreens, enabled by Web browsers and said Web server, for continually accessing and managing SQL databases in and manage by said SQL Server and using said systems by said buyers and providers in said network or networks;
a process for creating, implementing and applying said innovative computer programs and software and stored procedures coupled to said processor units, memories and SQL Server in said servers;
a process for continually generating said adaptable interactive linked Web pages and electronic templates and linked numerous interactive pop-up and drop-down lists in said viewing screens;
a process for generating and setting individual fixed or non-negotiable costs, rates and charges of individual health and health-care services, goods, equipment and medications, in said individual categories, represented by said individual words, terms, phrases and sentences using said adaptable interactive linked Web pages and electronic templates, processor units and memories by said related said individual providers and implementing said individual set or non-negotiable costs, rates and charges and related said individual words, terms, phrases and sentences in said functioning and operating computerized systems of payments and related disbursements and barters in said servers;
a process for negotiating, varying, adjusting and setting individual costs, rates and charges of individual health and health-care services, goods, equipment and medications in said servers using successive said adaptable interactive linked Web pages and electronic templates by and among said individual buyers and related said individual providers and related said demographic information and data on said individual providers and individual buyers related to individual health-care consumers; and, sequentially,
a process for continually and sequentially calculating, computing, statistically analyzing said individual costs, rates and charges generated, varied, adjusted and negotiated by and between said individual buyers and related individual providers related to said individual demographic information and data on said buyers and providers in said processor units, memories and outputting said calculated and computed said individual costs, rates and charges to, to be related and compiled in said adaptable and expanding SQL databases; and, consequently,
a process for creating and generating said plurality of components of said computerized system for generating individual fixed or non-negotiable costs, rates or charges and for generating negotiable, variable, adjustable and agreed or set individual costs, rates or charges generated in said adaptable interactive linked Web pages and electronic templates, processor units and memories and SQL databases in said adaptable interactive linked Web pages and electronic templates and linked numerous interactive pop-up and drop-down lists and said processor units, memories and SQL databases;
a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers in interactive boxes for enabling, adjusting, updating and adapting said individual costs, rates or charges related to said individual providers and related said individual buyers;
a process for computer-automatically and continually implementing and serving said plurality of components of said computerized system in said functioning and operating computerized systems of payments and related disbursements and barters in said servers; and
a process for setting and resetting or switching the applications of said components of said computerized system in said functioning and operating computerized systems of payments and related disbursements and barters in said servers by said individual providers.

9. The method according to claim 8 wherein said process for continually generating and displaying adaptable interactive linked Web pages and electronic templates and numerous linked interactive pop-up and drop-down lists in said viewing screens comprises:
i) a process for relating, composing and compiling relations of individual words, terms, phrases and sentences, which are integral components of said health, health-care and health-care-service information and data on or relating to diseases and disorders and patients used and use by physicians of all and diverse medical and surgical practices or specialties for and in the communications of said information and data among and between physicians and between physicians and patients, representing individual payable health-care and health-care services in said medical and surgical categories of Evaluations, Laboratories, Imaging, Body Fluid Tests and Tissues Examinations, Medications, Devices, Equipment, Procedures, Treatments, Surgeries, Recommendations, Guidelines, Referrals, related to individual diagnoses or individual diagnoses in individual groups of same, equivalent or similar diagnoses of diseases and disorders, and, if desirable, related individual prices, monetary values or costs and related individual buyers and individual providers and demographic information and data on said individual providers and individual buyers related to individual health-care consumers in said adaptable interactive linked Web pages and electronic templates in HTML, .net, Wordpad, Notepad, or .txt programs in the viewing screens of said computers and/or laptops and submitting said relations, compositions and, compilations to said processor units and memories and SQL databases in and manage by said SQL Server;
ii) upon prompting by said devices, a process for computer-automatically and continually retrieving, generating and expressing adaptable relations, compositions and compilations in interactive boxes for displaying said relations, compositions and compilations and related interactive boxes for keyboarding related individual fixed or non-negotiable costs, rates and charges by individual providers or related interactive boxes for keyboarding related individual variable, adjustable or negotiable asking costs, rates and charges, in HTML, by individual providers and submitting said relations by said individual providers to said processor units and memories and computer-automatically outputting said relations and compositions to, to be related and compiled in said adaptable and expanding SQL databases in and manage by said SQL Server from which said relations, compositions and compilations and related mathematical computations of said costs, rates and charges and related individual payable health-care and health-care services, goods, equipment and medications, subsequently, are computer-automatically retrieved and inputted into said processor units and memories to be continually displayed in said adaptable interactive linked Web pages and electronic templates and numerous linked interactive pop-up and drop-down lists in said viewing screens, for sequentially adapting, varying, adjusting, updating and setting by said individual providers, in said processor units, memories and SQL databases; or
iii) upon prompting by said devices, a process for computer-automatically and continually retrieving, generating and expressing adaptable relations, compositions and compilations in interactive boxes for displaying said relations, compositions and compilations and related interactive boxes for keyboarding related individual variable, adjustable or negotiable asking costs, rates and charges by individual providers and related interactive boxes for keyboarding by individual providers and subsequently, reciprocally and successively by related individual buyers and submitting said relations by said individual providers and, subsequently, reciprocally and successively, by said related individual buyers to said processor units and memories and computer-automatically outputting said relations and compositions to, to be related and compiled in said adaptable and expanding SQL databases in and manage by said SQL Server from which said successive or sequential relations, compositions and compilations and related mathematical computations of said costs, rates and charges and related individual payable health-care and health-care services, goods, equipment and medications, subsequently, are computer-automatically retrieved and inputted into said processor units and memories to be continually displayed in said adaptable interactive linked Web pages and electronic templates and numerous linked interactive pop-up and drop-down lists in said viewing screens, for sequentially adapting, varying, adjusting, updating and setting by and between said individual providers and related individual buyers, in said processor units, memories and SQL databases.

10. The method according to claim 8 wherein said process for creating and generating said plurality of components of said computerized system for generating individual fixed or non-negotiable costs, rates or charges and for generating negotiable, variable, adjustable and agreed or set individual costs, rates or charges generated in said adaptable interactive linked Web pages and electronic templates, processor units and memories and SQL databases in said adaptable interactive linked Web pages and electronic templates and linked numerous interactive pop-up and drop-down lists and said processor units, memories and SQL databases comprises:
i) upon prompting by said devices, said process for continually generating templates and numerous linked interactive pop-up and drop-down lists in said viewing screens for said individual physicians and related individual buyers;
ii) a process for creating and generating said individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers by said individual providers;
iii) a process for creating and generating said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers;
iv) a process for computer-automatically, sequentially and continually calculating, computing and mathematically manipulating and statistical analyzing said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data; and
v) if effected by said individual providers, a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers using said interactive boxes for enabling, adjusting, updating and adapting, setting and resetting said individual costs, rates or charges related to said individual providers and related said individual buyers.

11. The process for creating and generating said individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers by said individual providers according to claim 10 comprises:
a process for computer-automatically and continually generating adaptable interactive linked Web pages and electronic templates and numerous linked interactive pop-up and drop-down lists in said viewing screens, enabled by JavaScript, AJAX and HTML, innovative computer programs and software, stored procedures, Web browsers and Web server, comprising said adaptable and expanding SQL databases in said processor units, memories and SQL Server, comprising individual lists of descriptions of individual payable health-care and health-care services in said categories of Evaluations, Laboratories, Imaging, Body Fluid Tests and Tissues Examinations, Medications, Devices, Equipment, Procedures, Treatments, Surgeries, Recommendations, Guidelines, Referrals related to individual diagnoses or individual diagnoses in individual groups of same, equivalent or similar diagnoses of diseases and disorders, related to said individual buyers, demographies including individual zip codes and locations of said providers and buyers, related medical and surgical specialties, practices and institutions, and related interactive boxes for keyboarding individual set or non-negotiable prices, monetary values or costs of said individual payable health-care and health-care services related to said individual providers and submitted to said processor units and memories and outputted to, to be related and compiled in said adaptable and expanding SQL databases in and manage by said SQL Server from which said databases are subsequently and computer-automatically inputted into said processor units and memories to serve, in said functioning and operating computerized systems of payments and related disbursements and barters, as individual asking and set prices, monetary values or costs particular to said individual providers related to said individual words, terms, phrases and sentences for computer-automatically enabling and effecting computer-automatically and repetitively scanning and matching said individual words, terms, phrases and sentences with same, similar and equivalent words, terms, phrases and sentences subsequently and continually generated and submitted to said processor units and memories by said individual providers; and
if effected by said individual providers, a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers using said interactive boxes for enabling, adjusting, updating and adapting, setting and resetting said individual costs, rates or charges related to said individual providers and related said individual buyers.

12. The process for creating and generating said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers according to claim 10 comprises:
said process for continually generating and displaying adaptable interactive linked Web pages and electronic templates and numerous linked interactive pop-up and drop-down lists in said viewing screens and using said adaptable interactive linked Web pages and electronic templates and numerous linked interactive pop-up and drop-down lists and related interactive boxes for successively keyboarding or generating individual variable, adjustable or negotiable asking prices, monetary values or costs by said individual providers and, reciprocally and sequentially, related interactive boxes for successively keyboarding or generating different or edited, agreed and set individual costs, rates or charges related to said individual variable, adjustable or negotiable asking prices, monetary values or costs, of said individual providers, related to said individual health and health-care services, goods, equipment and medications by said related said individual buyers and consumers and related demographic information and data in said processor units and memories, by and between said individual providers and related said individual buyers; and, consequently,
a process for computer-automatically and successively outputting said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data to, to be related and compiled in said adaptable and expanding SQL databases in and manage by said SQL Server,
from which said relations, compositions and compilations in said SQL databases are subsequently and computer-automatically retrieved, upon prompting by said devices, and inputted into said processor units and memories to be retrieved and displayed in said adaptable interactive linked Web pages and electronic templates and numerous linked interactive pop-up and drop-down lists in said viewing screens and for adjusting, adapting, updating, setting and resetting said relations, compositions and compilations by and between said individual providers and related individual buyers using related interactive boxes for successively keyboarding individual prices, monetary values or costs by and between said individual buyers and related said individual providers for effecting said successive or sequential relations, compositions and compilations in said processor units, memories and adaptable and expanding SQL databases; and
if effected by said individual providers, a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers in interactive boxes for enabling, adjusting, updating and adapting said individual costs, rates or charges related to said individual providers and related said individual buyers.

13. The process for successively or sequentially calculating, computing and mathematically manipulating and statistical analyzing said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data according to claim 10 comprises:
said process for creating and generating said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers;
said process for creating and generating said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers;
a process for computer-automatically, sequentially and continually calculating, computing, statistically analyzing, and compiling said successive or sequential relations, compositions and compilations of said individual variable, adjustable, negotiated and agreed or set individual costs, rates and charges related to said individual health and health-care services, goods, equipment and medications related to said providers and related buyers and related demographic information and data in said processor units and memories from which successive or sequential mathematical calculations, computations and manipulations and statistical analyses of said successive or sequential relations, compositions and compilations related to said providers and related said buyers and related demographic information and data are outputted to, to be related and compiled in said adaptable and expanding SQL databases in and manage by said SQL Server enabled and effected by and according to said innovative computer programs and software and stored procedures;
if effected by said individual providers, a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers in interactive boxes for enabling, adjusting, updating and adapting said individual costs, rates or charges related to said individual providers and related said individual buyers; and
said process for setting and resetting or switching the applications of said components of said computerized system in said functioning and operating computerized systems of payments and related disbursements and barters in said servers by said individual providers.

14. The method according to claim 8 wherein said process for computer-automatically and continually implementing and serving said plurality of components of said computerized system in said functioning and operating computerized systems of payments and related disbursements and barters in said processor units and memories comprises:
i) a process for computer-automatically and continually implementing and serving said individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers by said individual providers;
ii) a process for computer-automatically and continually implementing and serving said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers; and/or
iii) a process for computer-automatically and continually implementing and serving said successive or sequential calculations, computations and mathematically manipulations of said successive or sequential relations, compositions and compilations of said individual variable, adjustable, negotiated and agreed or set individual costs, rates or charges related to said individual health and health-care services, goods, equipment and medications related to said providers and related said buyers and related demographic information and data; and
iv) a process for computer-automatically and continually implementing and serving said adjusted, set and reset said relations, compositions and compilations of said individual costs, rates and charges related to individual health and health-care services, goods, equipment and medications in interactive linked Web pages and electronic templates, processor units and memories and SQL databases by said individual providers.

15. The method according to claim 8 wherein said process for setting and resetting or switching the applications of said components of said computerized system in said functioning and operating computerized systems of payments and related disbursements and barters in said servers by said individual providers comprises a process for continually selecting and applying any said component or any combinations of said components of said computerized system for generating individual fixed or non-negotiable costs, rates or charges and for generating negotiable, variable, adjustable and agreed or set individual costs, rates or charges in said functioning and operating computerized systems of payments and related disbursements and barters in said servers.

16. In a computerized system for generating individual fixed or non-negotiable costs, rates or charges of individual health and health-care services, goods, equipment and medications represented by individual words, terms, phrases and sentences in individual medical and surgical categories by physicians, individual physicians, individual groups of physicians, individual hospitals, individual health-care clinics, individual health-care facilities or individual departments henceforth collectively known as individual providers and for generating negotiable, variable, adjustable and set or agreed individual costs, rates or charges of said individual health and health-care services, goods, equipment and medications by and between individual providers and individual health-care buyers, individual groups of health-care buyers, individual consumers, individual groups of consumers or individual governments henceforth collectively known as individual buyers for implementing and serving in the functioning and operating computerized systems of payments and related disbursements and barters resulting in individual varied and adjusted health-care costs and expenses and related individual payments, compensations and revenues of, by and between said individual buyers and related said individual providers for managing, effecting and controlling said costs, expenses, payments, compensations and revenues of, by and among said individual buyers and related individual providers in a functioning and operating computer server or servers henceforth servers in a network or networks of said servers, computers, laptops, mobile and wireless communication devices, teleconferencing platforms and the Internet being used by said buyers and providers, a method for managing, effecting and controlling said costs, expenses, payments, compensations and revenues of, by and among said individual buyers and related individual providers using adaptable interactive linked Web pages and electronic templates for enabling and managing said non-negotiations, variations, adjustments, negotiations and sets of said costs, rates and charges in said servers and computers, devices and teleconferencing platforms for accessing said servers in said network or networks comprises:
a process for operating and applying said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and innovative computer programs and software coupled to, communicating with and commanding said SQL Server, processor units and memories, adaptable interactive linked Web pages and electronic templates and numerous linked interactive pop-up and drop-down lists in said viewing screens, a plurality of components of said computerized system and functioning and operating computerized systems of payments and related disbursements and barters, teleconferencing technologies and related devices and equipment, said computers, laptops and devices comprising keyboards and viewing screens including touch-enabled viewing screens or touchscreens, enabled by Web browsers and said Web server, for continually accessing and managing SQL databases in and manage by said SQL Server and using said systems by said buyers and providers in said network or networks;
a process for creating, implementing and applying said innovative computer programs and software and stored procedures coupled to said processor units, memories and SQL Server in said servers;
a process for continually generating said adaptable interactive linked Web pages and electronic templates and linked numerous interactive pop-up and drop-down lists in said viewing screens;
a process for generating and setting individual fixed or non-negotiable costs, rates and charges of individual health and health-care services, goods, equipment and medications, in said individual categories, represented by said individual words, terms, phrases and sentences using said adaptable interactive linked Web pages and electronic templates, processor units and memories by said related said individual providers and implementing said individual set or non-negotiable costs, rates and charges and related said individual words, terms, phrases and sentences in said functioning and operating computerized systems of payments and related disbursements and barters in said servers;
a process for negotiating, varying, adjusting and setting individual costs, rates and charges of individual health and health-care services, goods, equipment and medications in said servers using successive said adaptable interactive linked Web pages and electronic templates by and among said individual buyers and related said individual providers and related said demographic information and data on said individual providers and individual buyers related to individual health-care consumers; and, sequentially,
a process for continually and sequentially calculating, computing, statistically analyzing said individual costs, rates and charges generated, varied, adjusted and negotiated by and between said individual buyers and related individual providers related to said individual demographic information and data on said buyers and providers in said processor units, memories and outputting said calculated and computed said individual costs, rates and charges to, to be related and compiled in said adaptable and expanding SQL databases; and, consequently,
a process for creating and generating said plurality of components of said computerized system for generating individual fixed or non-negotiable costs, rates or charges and for generating negotiable, variable, adjustable and agreed or set individual costs, rates or charges generated in said adaptable interactive linked Web pages and electronic templates, processor units and memories and SQL databases in said adaptable interactive linked Web pages and electronic templates and linked numerous interactive pop-up and drop-down lists and said processor units, memories and SQL databases;
a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers in interactive boxes for enabling, adjusting, updating and adapting said individual costs, rates or charges related to said individual providers and related said individual buyers; and
a process for computer-automatically and continually implementing and serving said plurality of components of said computerized system in said functioning and operating computerized systems of payments and related disbursements and barters in said servers.

17. The method according to claim 16 wherein said process for creating and generating said plurality of components of said computerized system for generating individual fixed or non-negotiable costs, rates or charges and for generating negotiable, variable, adjustable and agreed or set individual costs, rates or charges generated in said adaptable interactive linked Web pages and electronic templates, processor units and memories and SQL databases in said adaptable interactive linked Web pages and electronic templates and linked numerous interactive pop-up and drop-down lists and said processor units, memories and SQL databases comprises:
i) upon prompting by said devices, said process for continually generating and displaying adaptable interactive linked Web pages and electronic templates and numerous linked interactive pop-up and drop-down lists in said viewing screens for said individual physicians and related individual buyers;
ii) a process for creating and generating said individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers by said individual providers;
iii) a process for creating and generating said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers;
iv) a process for computer-automatically, sequentially and continually calculating, computing and mathematically manipulating and statistical analyzing said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data; and
v) if effected by said individual providers, a process for adjusting, setting and resetting said relations, compositions and compilations of said individual costs, rates and charges related to individual health and health-care services, goods, equipment and medications in interactive linked Web pages and electronic templates, processor units and memories and SQL databases by said individual providers using said interactive boxes for enabling, adjusting, updating and adapting, setting and resetting said individual costs, rates or charges related to said individual providers and related said individual buyers.

18. The method according to claim 16 wherein said process for computer-automatically and continually implementing and serving said plurality of components of said computerized system in said functioning and operating computerized systems of payments and related disbursements and barters in said processor units and memories comprises:
i) a process for computer-automatically and continually implementing and serving said individual relations, compositions and compilations of said fixed or non-negotiable costs, rates or charges of individual health and health-care services, goods, equipment and medications related to said individual providers and related demographic information and data on said individual providers and interactive boxes for enabling, adjusting, updating, adapting and resetting said individual fixed or non-negotiable costs, rates or charges related to said individual providers by said individual providers;
ii) a process for computer-automatically and continually implementing and serving said successive or sequential relations, compositions and compilations of said individual variable, adjustable, negotiated and agreed or set individual costs, rates or charges related to said individual health and health-care services, goods, equipment and medications related to individual providers and related individual buyers and related demographic information and data by and between said individual providers and related individual buyers related to individual health-care consumers; and/or
iii) a process for computer-automatically and continually implementing and serving said successive or sequential calculations, computations and mathematically manipulations of said successive or sequential relations, compositions and compilations of said individual variable, adjustable, negotiated and agreed or set individual costs, rates or charges related to said individual health and health-care services, goods, equipment and medications related to said providers and related said buyers and related demographic information and data; and
iv) a process for computer-automatically and continually implementing and serving said adjusted, set and reset said relations, compositions and compilations of said individual costs, rates and charges related to individual health and health-care services, goods, equipment and medications in interactive linked Web pages and electronic templates, processor units and memories and SQL databases by said individual providers.
